(19) United States
(12) Patent Application Publication
(10) Pub. No.: US 2025/0285272 A1
(43) Pub. Date: Sep. 11, 2025

(54) SYSTEMS AND METHODS FOR PROCESSING ELECTRONIC IMAGES OF CORES

(71) Applicant: PAIGE.AI, Inc., New York, NY (US)

(72) Inventors: Hamed H. AGHDAM, Calgary (CA); Marek Krzysztof BURZA, Munich (DE); Bonnie CHOW, Munich (DE); Ludmila TRLIFAJ TYDLITATOVA, Vienna (AT); Kasper MALFROID, Berlin (DE); Fausto MILLETARI, Isnello (IT); Danielle GORTON, Beacon, NY (US)

(21) Appl. No.: 19/073,876

(22) Filed: Mar. 7, 2025

Related U.S. Application Data
(60) Provisional application No. 63/563,031, filed on Mar. 8, 2024.

(51) Int. Cl. G06T 7/00; G06T 5/50; G06T 7/55; G06V 10/25; G06V 10/74

(52) U.S. Cl. CPC G06T 7/0012; G06T 5/50; G06T 7/55; G06V 10/25; G06V 10/761; G06T 2200/04; G06T 2207/20221; G06T 2207/30096; G06V 2201/03

(57) ABSTRACT

A computer-implemented method for analyzing electronic medical images, including: receiving a plurality of medical images associated with a patient; determining one or more bounding shapes for each of the plurality of medical images, each of the bounding shapes surrounding to a continuous tissue sample depicted in the plurality of medical images; based on the one or more bounding shapes, determining a plurality of levels of the tissue sample; and determining a three-dimensional association of the plurality of levels.

### RELATED APPLICATION

This application claims priority to U.S. Provisional Application No. 63/563,031 filed on Mar. 8, 2024, which is incorporated herein in its entirety.

### TECHNICAL FIELD

Various embodiments of the present disclosure pertain generally to pathology slide analysis and related methods. More specifically, particular embodiments of the present disclosure relate to systems and methods for identifying and analyzing multiple levels of core tissue.

### BACKGROUND

Pathology specimens may be cut into multiple sections, stained, and prepared as slides for a pathologist to examine and render a diagnosis. When uncertain of a diagnostic finding on a slide, a pathologist may review additionally cut levels, order additional stains, or other tests to gather more information from the tissue. Pathologists are limited in analyzing slides using two-dimensional (2D) measurements of length and width. The depth of the tissue spanning across the cut levels is not known or able to be seen. A desire exists for a way to enable pathologists to see and analyze the depth of the tissue.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### BRIEF DESCRIPTION OF THE DRAWINGS

FIGS. 1A-1E depict tissue masks of electronic images of pathology slides with varying numbers of cores and levels, according to an exemplary embodiment of the present disclosure.

FIGS. 2A-2B depict masks of electronic images of pathology slide with two cores, according to an exemplary embodiment of the present disclosure.

FIG. 3 depicts tissue masks of electronic images of a pathology slide with two cores, according to an exemplary embodiment of the present disclosure.

FIG. 4 depicts tissue masks of electronic images of a pathology slide with one core and two levels where the images have been extracted, according to an exemplary embodiment of the present disclosure.

FIG. 5 depicts tissue masks of electronic images of a pathology slide with bounding boxes, according to an exemplary embodiment of the present disclosure.

FIG. 6 depicts tissue masks of electronic images of a pathology slide with bounding boxes that have been combined, according to an exemplary embodiment of the present disclosure.

FIG. 7 depicts the pathology slide registration process, according to an exemplary embodiment of the present disclosure.

FIGS. 8A-8E depict the registration process as applied to three levels of one core, according to an exemplary embodiment of the present disclosure.

FIG. 9 depicts aligned levels of a given core, according to an exemplary embodiment of the present disclosure.

FIG. 10 depicts multiple benign cores grouped into a single image, according to an exemplary embodiment of the present disclosure.

FIGS. 11A-11B depict electronic images of pathology slides that have been restained and aligned, according to an exemplary embodiment of the present disclosure.

FIG. 12 is a flowchart of an exemplary method for determining a three-dimensional associations of core levels, according to an exemplary embodiment of the present disclosure.

FIG. 13 depicts resolving overlapping bounding boxes, according to an exemplary embodiment of the present disclosure.

FIG. 14 depicts an exemplary environment for generating an interactive display, according to one or more embodiments.

FIG. 15 depicts a flow diagram for training a machine-learning model, according to an exemplary embodiment of the present disclosure.

FIG. 16 depicts an example of a computing device, according to an exemplary embodiment of the present disclosure.

Notably, for simplicity and clarity of illustration, certain aspects of the figures depict the general configuration of the various embodiments. Descriptions and details of well-known features and techniques may be omitted to avoid unnecessarily obscuring other features. Elements in the figures are not necessarily drawn to scale; the dimensions of some features may be exaggerated relative to other elements to improve understanding of the example embodiments.

### SUMMARY

According to certain aspects of the present disclosure, computer-implemented system and methods are disclosed for analyzing electronic medical images, including: receiving a plurality of medical images associated with a patient; determining one or more bounding shapes for each of the plurality of medical images, each of the bounding shapes surrounding to a continuous tissue sample depicted in the plurality of medical images; based on the one or more bounding shapes, determining a plurality of levels of the tissue sample; and determining a three-dimensional association of the plurality of levels.

In some aspects, the techniques described herein relate to a method, wherein the bounding shapes are determined by determining the images of a tissue sample and identifying a contour region of each tissue.

In some aspects, the techniques described herein relate to a method, wherein determining a three-dimensional association includes determining an order of the plurality of levels of the tissue sample based on a similarity index.

In some aspects, the techniques described herein relate to a method, further including: stacking and displaying, based on the three-dimensional association, the plurality of levels into at least one multipanel view.

In some aspects, the techniques described herein relate to a method, further including: determining a plurality of benign core levels; and rendering the plurality of benign core levels into a single image view.

In some aspects, the techniques described herein relate to a method, wherein the plurality of medical images come from a single tissue that has been restained, and wherein the plurality of medical images are stacked to identify the same region across the plurality of medical images.

In some aspects, the techniques described herein relate to a method, wherein the bounding shapes include boxes.

According to certain aspects of the present disclosure, a system is disclosed for analyzing electronic medical images, the system including: receiving a plurality of medical images associated with a patient; determining one or more bounding shapes for each of the plurality of medical images, each of the bounding shapes surrounding to a continuous tissue sample depicted in the plurality of medical images; based on the one or more bounding shapes, determining a plurality of levels of the tissue sample; and determining a three-dimensional association of the plurality of levels.

In some aspects, the techniques described herein relate to a system, wherein the bounding shapes are determined by determining the images of a tissue sample and identifying a contour region of each tissue.

In some aspects, the techniques described herein relate to a system, wherein determining a three-dimensional association comprises determining an order of the plurality of levels of the tissue sample based on a similarity index.

In some aspects, the techniques described herein relate to a system, further including: stacking and displaying, based on the three-dimensional association, the plurality of levels into at least one multipanel view.

In some aspects, the techniques described herein relate to a system, further comprising: determining a plurality of benign core levels; and rendering the plurality of benign core levels into a single image view.

In some aspects, the techniques described herein relate to a system, wherein the plurality of medical images come from a single tissue that has been restained, and wherein the plurality of medical images are stacked to identify the same region across the plurality of medical images.

In some aspects, the techniques described herein relate to a system, wherein the bounding shapes include boxes.

According to certain aspects of the present disclosure, a non-transitory computer-readable medium is disclosed for storing instructions that, when executed by a processor, perform operations for analyzing electronic medical images, the operations including: receiving a plurality of medical images associated with a patient; determining one or more bounding shapes for each of the plurality of medical images, each of the bounding shapes surrounding to a continuous tissue sample depicted in the plurality of medical images; based on the one or more bounding shapes, determining a plurality of levels of the tissue sample; and determining a three-dimensional association of the plurality of levels.

In some aspects, the techniques described herein relate to a non-transitory computer-readable medium, wherein the bounding shapes are determined by determining the images of a tissue sample and identifying a contour region of each tissue.

In some aspects, the techniques described herein relate to a non-transitory computer-readable medium, wherein determining a three-dimensional association comprises determining an order of the plurality of levels of the tissue sample based on a similarity index.

In some aspects, the techniques described herein relate to a non-transitory computer-readable medium, further including: stacking and displaying, based on the three-dimensional association, the plurality of levels into at least one multipanel view.

In some aspects, the techniques described herein relate to a non-transitory computer-readable medium, further including: determining a plurality of benign core levels; and rendering the plurality of benign core levels into a single image view.

In some aspects, the techniques described herein relate to a non-transitory computer-readable medium, wherein the plurality of medical images come from a single tissue that has been restained, and wherein the plurality of medical images are stacked to identify the same region across the plurality of medical images.

### DETAILED DESCRIPTION

Various aspects of the present disclosure relate generally to computer-implemented techniques for image processing, such as whole slide images (WSI) obtained using medical imaging. Aspects disclosed herein may provide digital tools configured to conceptualize and reconstruct two-dimensional images (e.g., WSIs).

Techniques described in the current disclosure may utilize systems and methods described in U.S. application Ser. No. 17/107,433, U.S. application Ser. No. 17/126,596, U.S. application Ser. No. 17/313,617, and U.S. application Ser. Nos. 17/732,857, 18/643,400, 17/014,532, 17/350,328, and U.S. application Ser. No. 17/313,617, all of which are incorporated herein by reference.

As used herein, the term “exemplary” is used in the sense of “example,” rather than “ideal.” Moreover, the terms “a” and “an” herein do not denote a limitation of quantity, but rather denote the presence of one or more of the referenced items.

Biological structures (e.g., tumors) may be irregular, three-dimensional shapes. Aspects disclosed herein may take these three-dimensional structures into account to present new opportunities for understanding pathology and treating or addressing pathological illnesses such as cancer.

Physical glass slides may represent one instance of a sample (e.g., treated tissue) at a given point in time. Multiple, spatially similar sections of very thin slices of tissue may be prepared to assess different and/or separate treatments for the tissue. For example, a pathologist may desire a secondary stain to further investigate or verify findings from a first stain, such as a hematoxylin and eosin (H&E) slide. In some cases, secondary stains are immunohistochemical (IHC) stains, but may be other secondary stains, sometimes referred to as “special stains,” or “esoteric stains.” Some forms of secondary stains may be considered permanent or destructive, in that the stain reagents are permanent and cannot be removed from the tissue sample, or that they permanently alter the composition of the tissue sample itself. The H&E slide may be prepared and reviewed by the pathologist, and then a similar piece or slice of tissue may be treated with the IHC stain on a separate glass slide. Pathologists may “co-register” the two slices or pieces of tissue, which may be nearly identical, on these glass slides to reconcile findings among the different preparations (here, the IHC and H&E preparations). Pathologists may co-register the two slices or pieces by alternating between their corresponding slides on a microscope and/or by physically overlaying the slides for review by a naked eye and/or via a microscope.

Therefore, the present disclosure provides for machine-learning and artificial intelligence based techniques of image processing. The logistical and financial challenges and/or undesired results or errors associated with manual analysis of images may also be reduced. More specifically, techniques disclosed herein to generate a navigable three-dimensional image of a tissue sample may provide for faster, real-time, more accurate, and more efficient processing of image data and/or diagnosis pertaining to analysis of image data in comparison to conventional techniques. Techniques disclosed herein further reduce the computational resources required for such processing by, for example, leveraging machine-learning training to reduce just-in-time processing loads.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine-learning techniques, such as a transformer model, graph neural network (GNN), linear regression, logistic regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine-learning and artificial intelligence, it should be understood that techniques according to this disclosure may be adapted to any suitable type of machine-learning and/or artificial intelligence. It should also be understood that the examples above are illustrative only. The techniques and technologies of this disclosure may be adapted to any suitable activity.

While various aspects relating to medical imaging and medical diagnostics (e.g., diagnosis of a medical condition based on medical imaging) are described in the present aspects as illustrative examples, the present aspects are not limited to such examples. For example, the present aspects can be implemented for other types of image processing.

Reference will now be made in detail to the exemplary embodiments of the present disclosure, examples of which are illustrated in the accompanying drawings. Wherever possible, the same reference numbers will be used throughout the drawings to refer to the same or like parts.

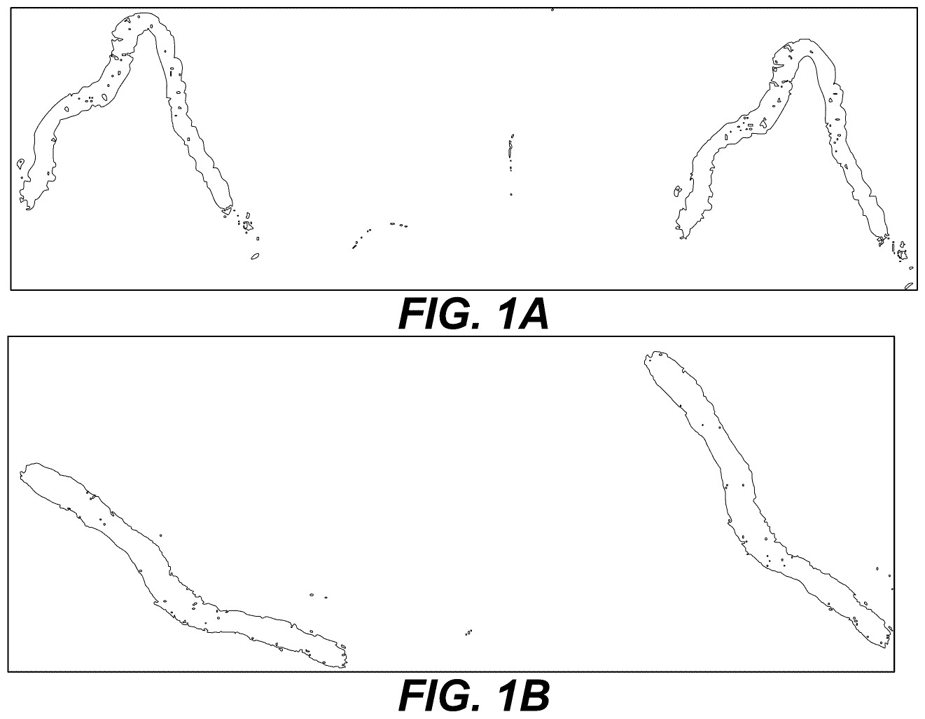

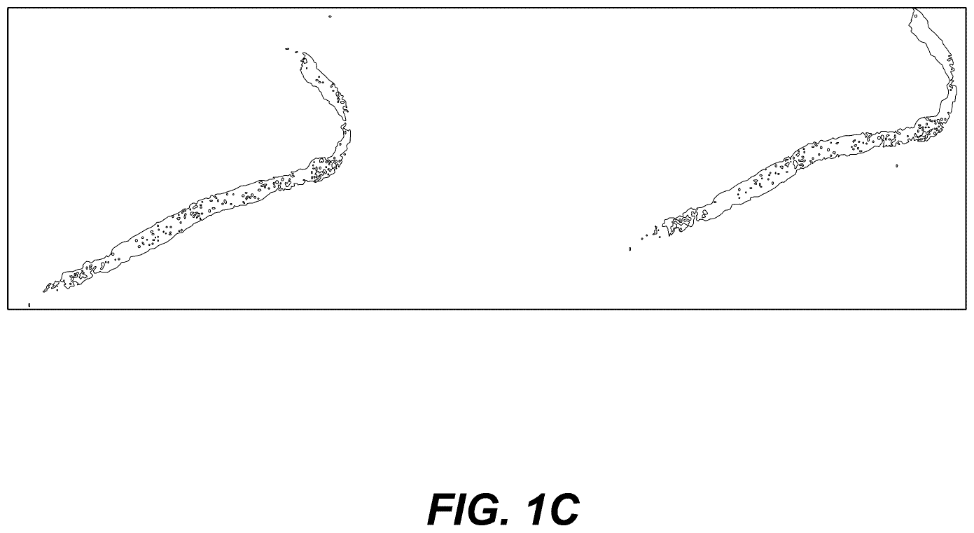

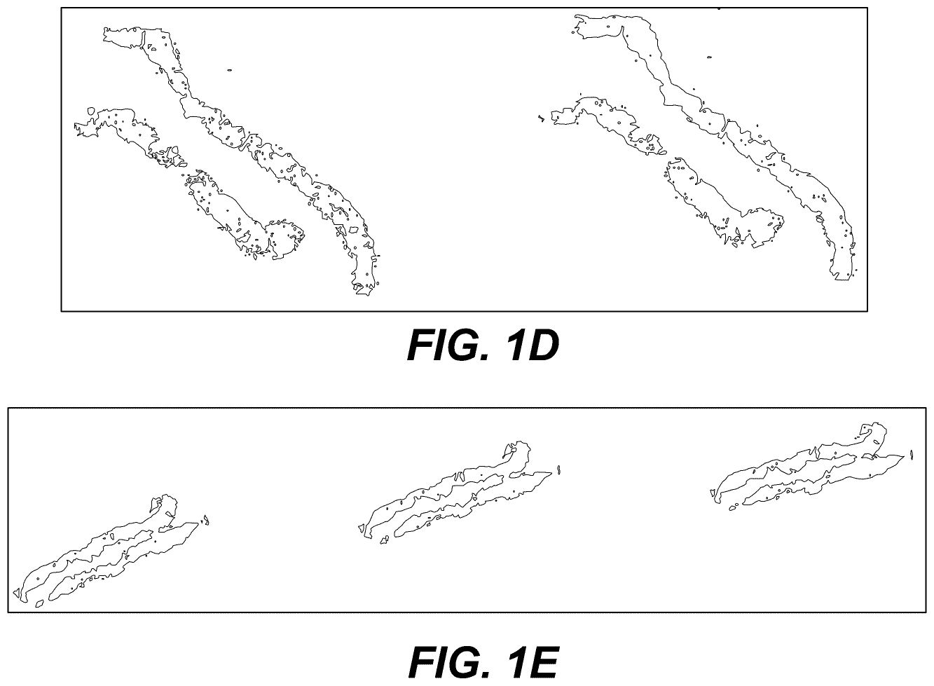

In the present disclosure, a single block of a pathology specimen is referred to as a core. As a core may be cut into multiple sections, and prepared as a slide, each one of those sections is referred to herein as a level. FIGS. 1A-1E illustrate this concept. FIGS. 1A-C depict single cores that have been sectioned into two levels. FIG. 1D depicts two cores that have been sectioned into two levels each. FIG. 1E depicts two cores that have been sectioned into three levels each.

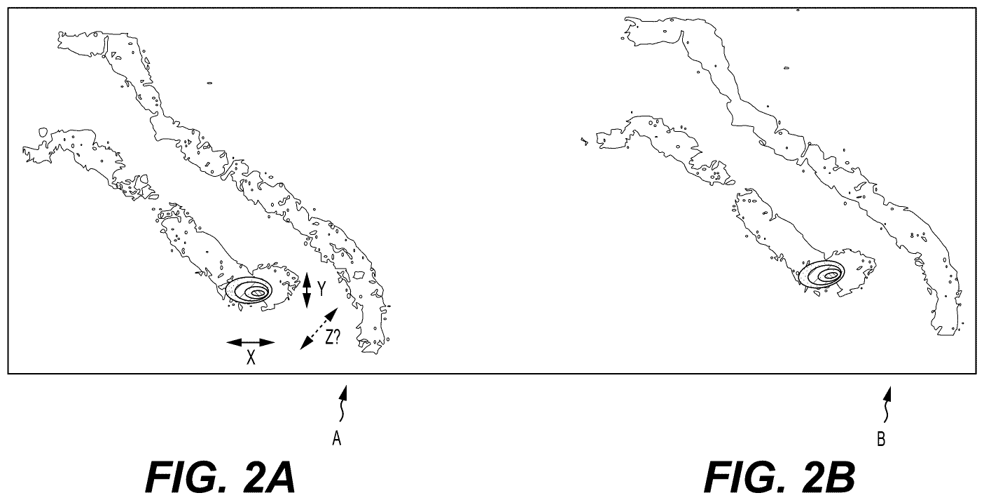

Without application of techniques presented herein, individual levels of pathology samples are only viewable and analyzable in two dimensions (2D): height and length. This does not permit consideration of a third dimension—the depth of a feature in the tissue. FIGS. 2A-2B show two cores that have been sectioned into two levels each. As can be seen in portion A, the height and length (x and y) components are examined, but the depth component (z) is not taken into consideration. This is problematic because certain pathologies (e.g., cancer) might exist on one level but not another. Additionally, certain pathologies (i.e., cancer) may be asymmetrically distributed throughout the tissue and extend in one direction more than the others. If during the sectioning process, the tissue is cut in a perpendicular direction as the cutting plane, then the longest dimension of the cancer tissue will not be apparent on a 2D cross section. This may lead to an inaccurate diagnosis and an underestimation of a cancerous tumor's spread.

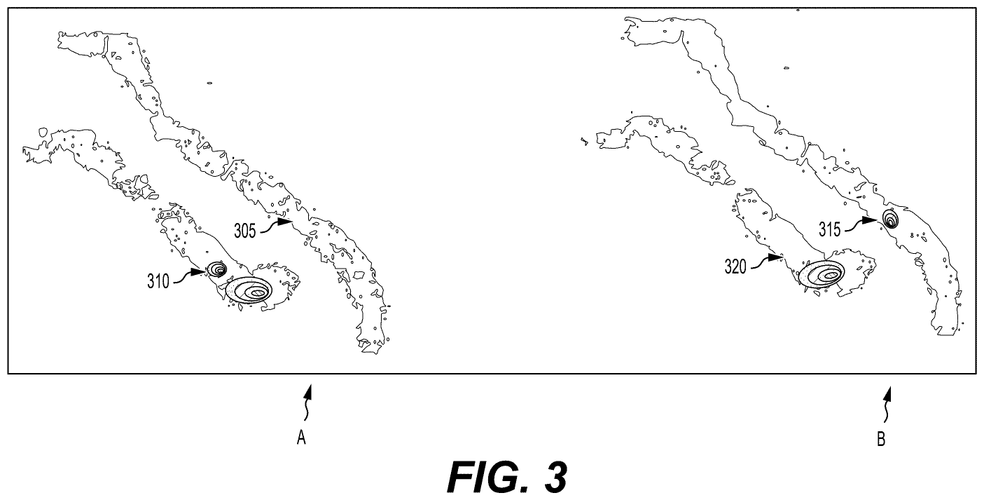

FIG. 3 depicts electronic images of two cores of a prostate biopsy sectioned into two levels each, portion A shows one level while portion B shows another level. The two arrows in portions A and B show the same locations at different depths (levels). However, while the arrow 315 is pointing to a malignant (cancerous) region in portion B, that malignancy does not appear in the same region in portion A at 305. Similarly, while the arrow 310 is pointing to a cancerous region, no abnormality is present in portion B at 320.

The ability to analyze multiple levels of the same core at the same time and getting a three-dimensional (3D) view is an unmet need in pathology and will greatly aid pathologists in accurately identifying tissue abnormalities.

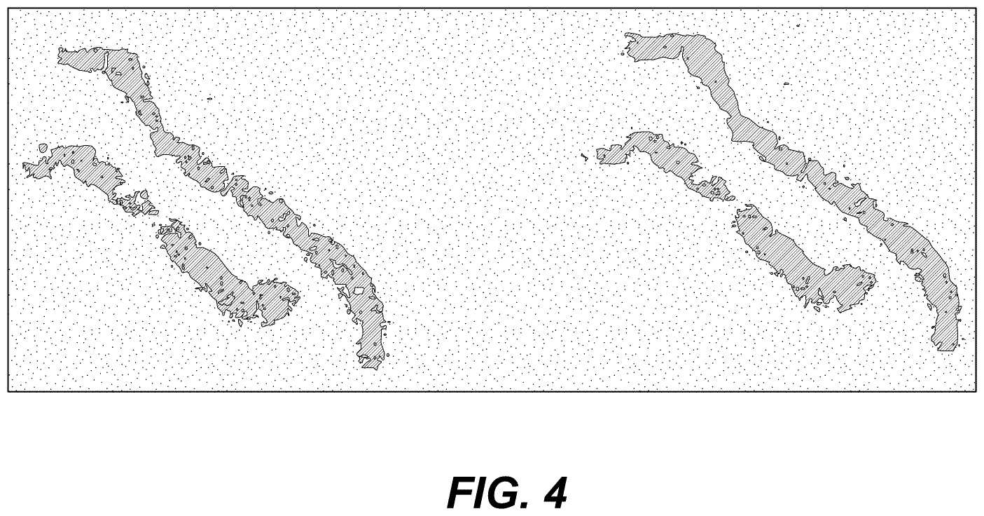

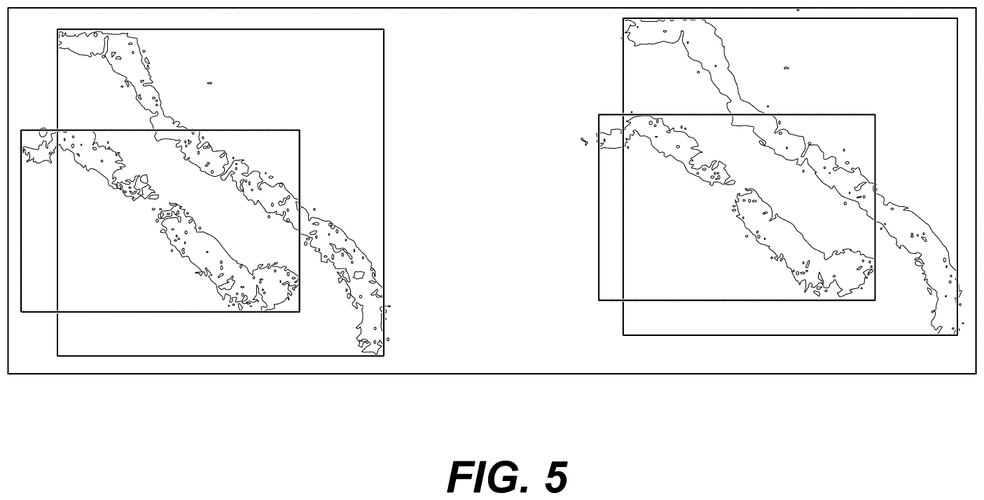

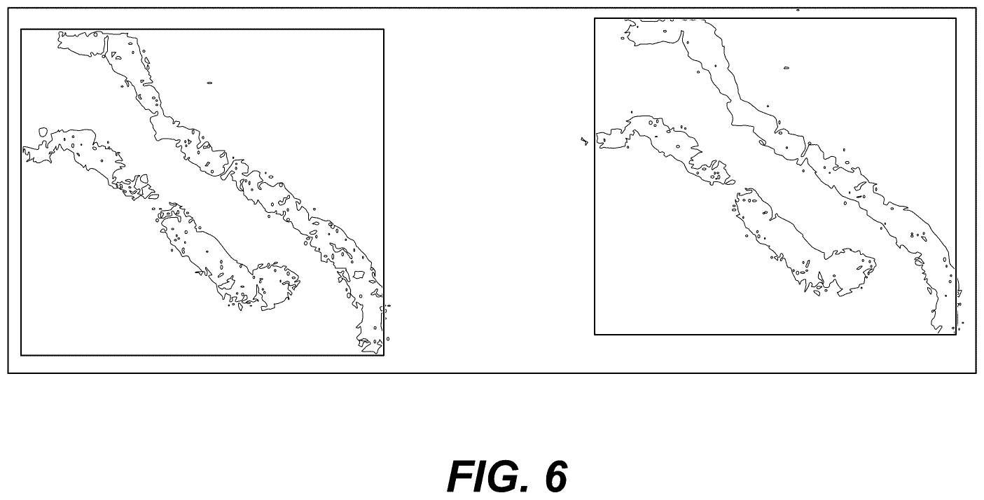

The present disclosure describes methods and systems for processing images to enable tissue analysis in three dimensions. This may be a multistep process that begins with a foreground extractor to segment tissue regions with pixel-level accuracy, as exampled in FIG. 4. A machine learning/artificial intelligence model may determine if each pixel is tissue or non-tissue. In another step, the contour region of each tissue may be determined. In a further step, the extracted pixels/tile masks may be used to determine outline polygons. The outline polygons may be converted to bounding shapes such as bounding boxes as shown in FIG. 5. Outline polygons may also be determined directly from the images themselves. If it is determined that bounding boxes are overlapping, they may be grouped together, as shown in FIG. 6.

In another technique, a predetermined threshold distance, or predetermined degree of separation of bounding box centers, may be used to determine if bounding boxes are grouped/associated. The bounding shapes may comprise boxes, as exampled herein, or other polygons, contiguous lines at a predetermined offset or buffer distance surrounding the tissue, etc. Each tissue sample may receive a bounding shape, but where one tissue sample ends and another begins may be ambiguous. For example, a sample may be broken and have a gap between two pieces, or there may be two separate samples close to each other. Each sample may be identified and distinguished from each other by determining if gaps between candidate samples are below a minimum distance, where gaps below a minimum threshold distance may cause two pieces of tissue to be labeled as the same sample. Further, pieces of tissue with gaps may be assumed to be the same or different samples after contiguous tissue analysis, which may be performed by a machine learning algorithm. If two pieces of tissue on a sample image have a similar appearance, morphology, tissue type, and/or if the tissue pieces may be connected within a threshold, the pieces of tissue may be labeled as the same sample.

Images may further be ordered by automatically applying an algorithm to determine similarity metrics across each image. The similarity metrics may be referred to as similarity scores or similarity index. Images that are within a predetermined threshold may be co-registered. An image registration algorithm may be used to co-register images that are within the predetermined threshold. If two pieces of tissue, or portions thereof, have a similar overall shape beyond a predetermined threshold, they may be indicated as corresponding to different z-layers (alternatively referred to as layer, z-stacks, or z-levels) of the same core.

Alternatively, a given core level may be identified, and the closest match may be searched for in the slide. For every level later identified, a matching score is assigned. A match may be determined to be found when a threshold score is met. The two matching cores may be stacked and further analyzed as will be described below.

In another technique, many levels may be checked within one image, slide, and/or across multiple images to find matches corresponding to different levels.

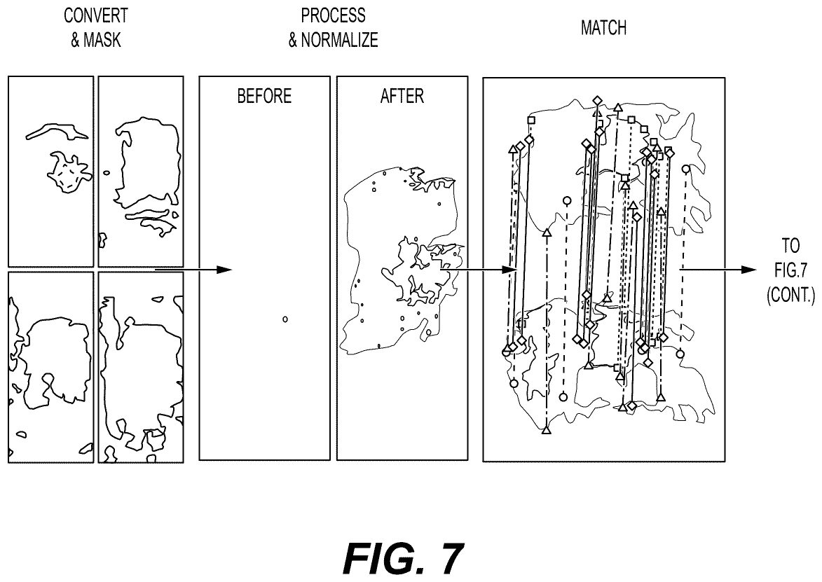

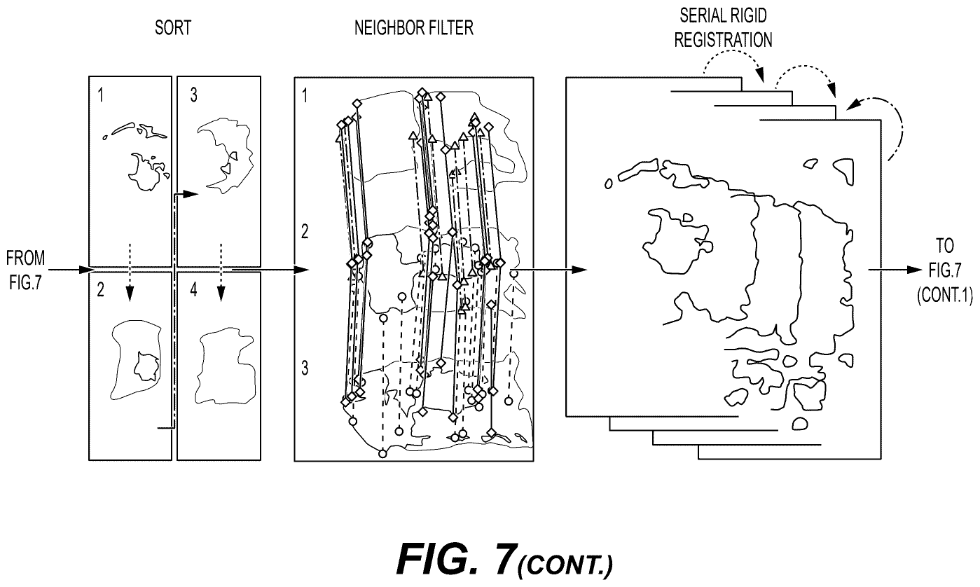

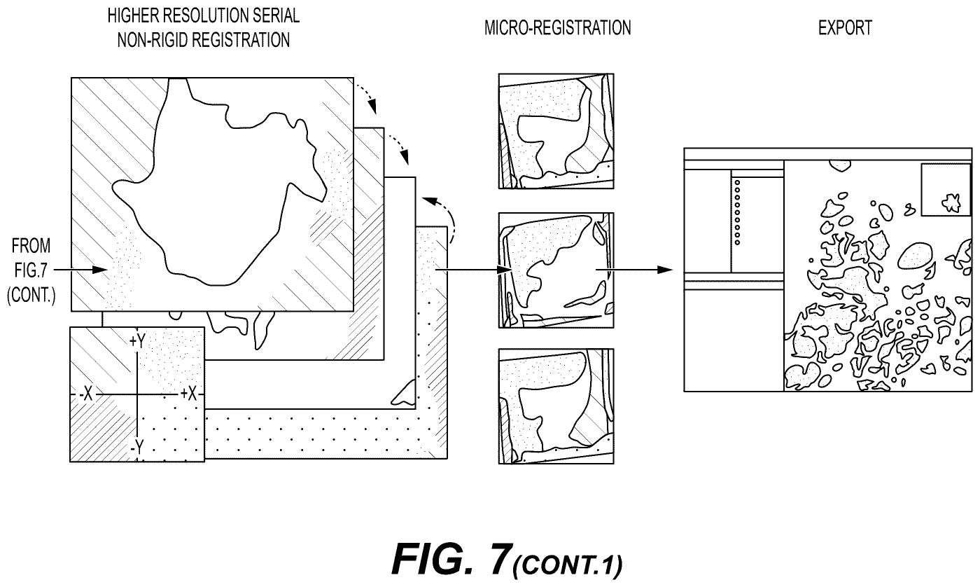

The detected cores may be registered using available libraries as shown in FIG. 7. During registration, the images of different levels of tissues may be moved around, rotated, and/or manipulated/transformed in order to allow for the identification of the match. These registration methods may be mathematical algorithms that use shapes or images as input. Output from the registration software may provide a transformation matrix which can be applied to an image to achieve the best possible overlap with another image. The transformation matrix may include a composition of rotation plus translation which may be calculated automatically by the image registration algorithm. Additionally, such output may provide a metric of how good the match of the two images is when overlaid on each other. For example, Intersection-over-Union (IoU) measurements may be used. Other metrics may be determined using the image registration algorithm. Utilizing bounding boxes for each of the pieces of tissue, registration software may be used to generate similarity s of given pairs. Only pairs with a similarity metric above a certain threshold may be considered part of the same core. The tissue similarity threshold may be set experimentally for an annotated set of slides with pieces of tissue known to belong to the same core. Tissues are sorted based on their pairwise similarity scores and z-stacked. Furthermore, the image registration algorithm may provide additional measures for co-registering images.

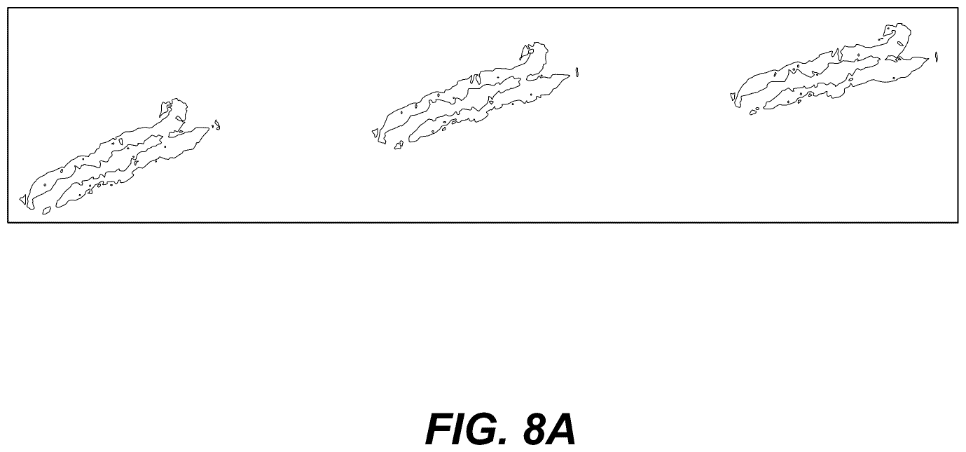

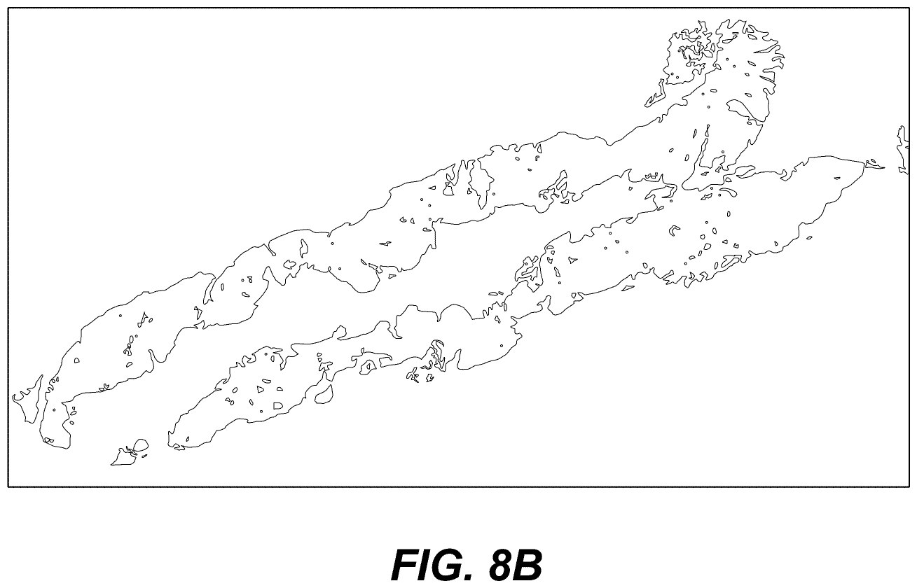

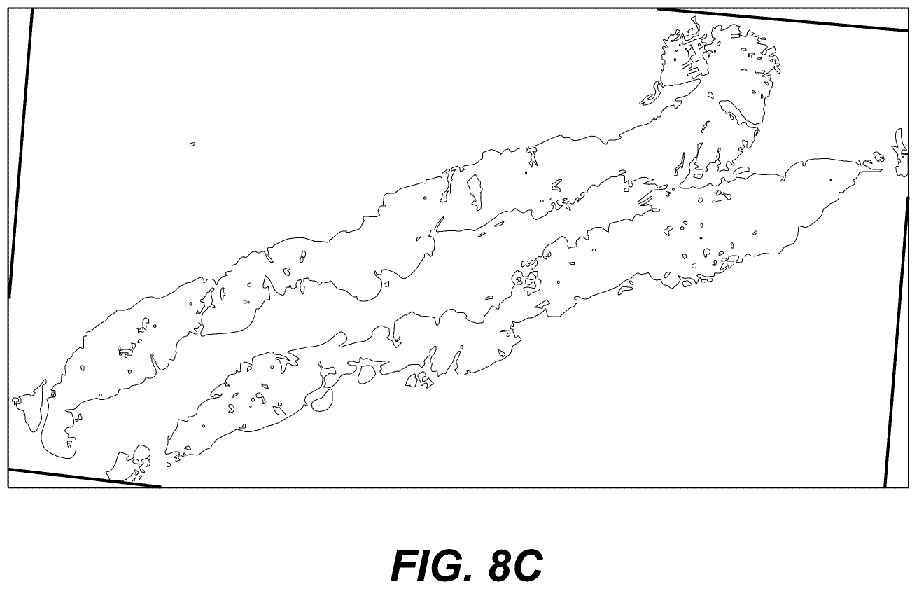

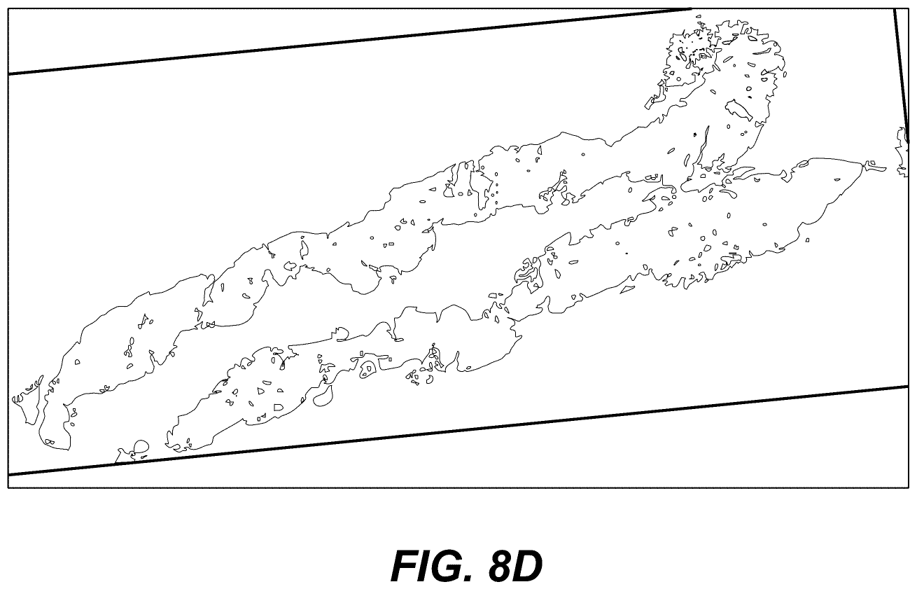

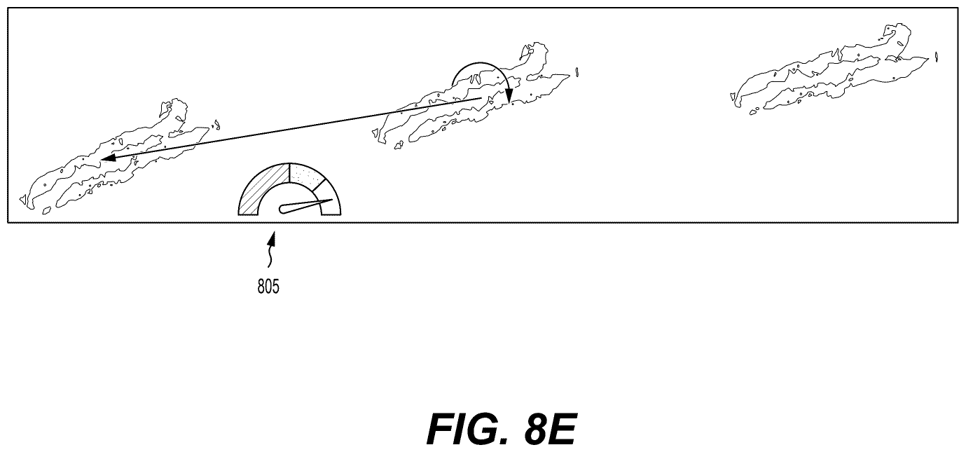

FIGS. 8A-E depict example outputs of the registration methods described above. FIG. 8A depicts a slide with three levels of one core. FIG. 8B depicts a first level that was extracted. This first extracted level image may be considered a reference image. FIGS. 8C and 8D illustrate how a non-reference image may be rotated and shifted during registration so that it can align with the reference image. The surrounding lines illustrate the way these images may be shifted to allow for alignment with the reference core image. FIG. 8E depicts the transformation applied to the slide from 8A and a similarity metric 805 indicating the closeness of the match.

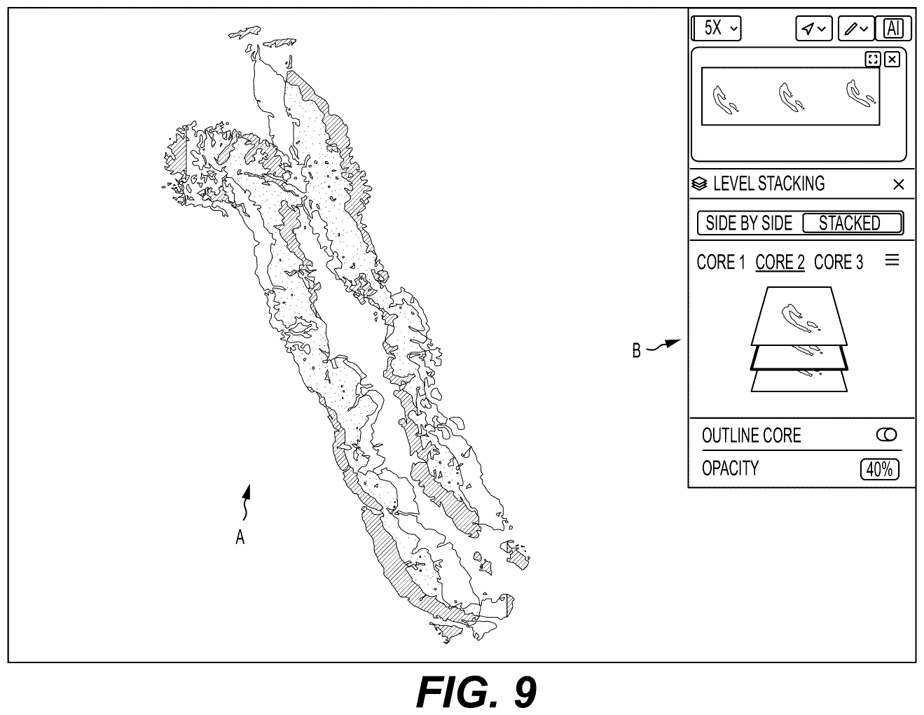

The registration and stacking of cores allows for multiple methods of pathology sample analysis. Two or more registered levels may be superimposed on one another as shown in FIG. 9, portion A, where the striped image depicts another z-level of the same sample. Different z-levels may be depicted as differing opacities, or with different color shades, such as somewhat grayed, or outlined in different colors, in order to allow the viewer to distinguish between z-levels. When the user selects a level to focus on, it may trigger the opacity of that level to be set to 0%, while the other levels are set to some predetermined value, for example 40%. Whether the cores are outlined, the level of opacity difference, and whether the levels are depicted as stacked or side-by-side may be configurable by the user via the user interface. The superimposition may be a graphical rendering of semitransparent images or the ability to swap one opaque image for another one. In a technique, multiple levels can be stacked on top of one another, as shown in portion B, and a pathologist can navigate through multiple levels with ease by selecting one. For example, a pathologist can analyze multiple levels individually or side-by-side.

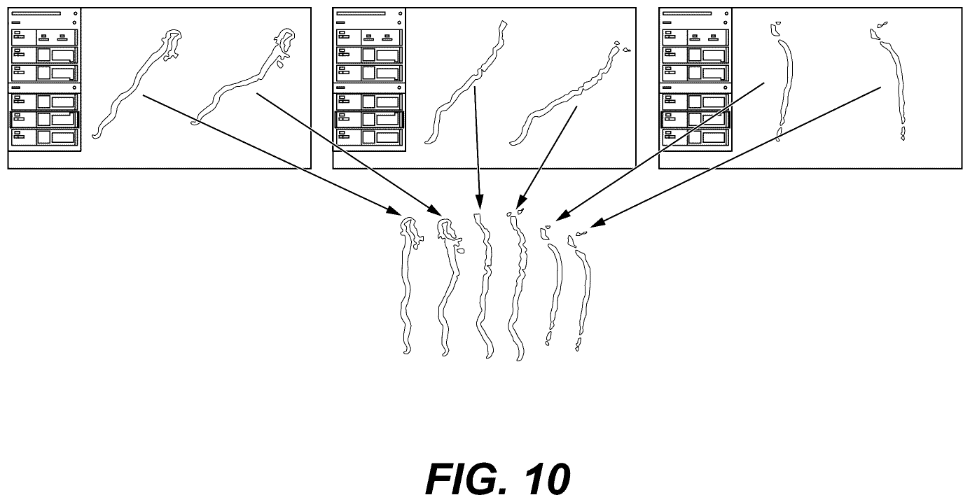

In a further technique, shown in FIG. 10, multiple cores and/or multiple levels of the same core can be grouped and displayed on a single canvas for a more efficient review by the pathologist.

Registered levels may also be shown in a multi-panel view, making sure that the middle of each panel, or other predefined reference point, is always registered with the tissue in the other panels, as described in the above in the discussion concerning FIGS. 7 and 8A-E. In another embodiment, registered levels coming from the same core can be linked and visualized in multiple ways. For example, a level that has been stained with Hemotoxyline and Eosin (H&E) can be linked with another level that has been stained with an antibody via immunohistochemistry (IHC). Additionally, different levels of the same core can be brought into spatial correspondence so that pathologies can evaluate them not only in 2D but also in 3D.

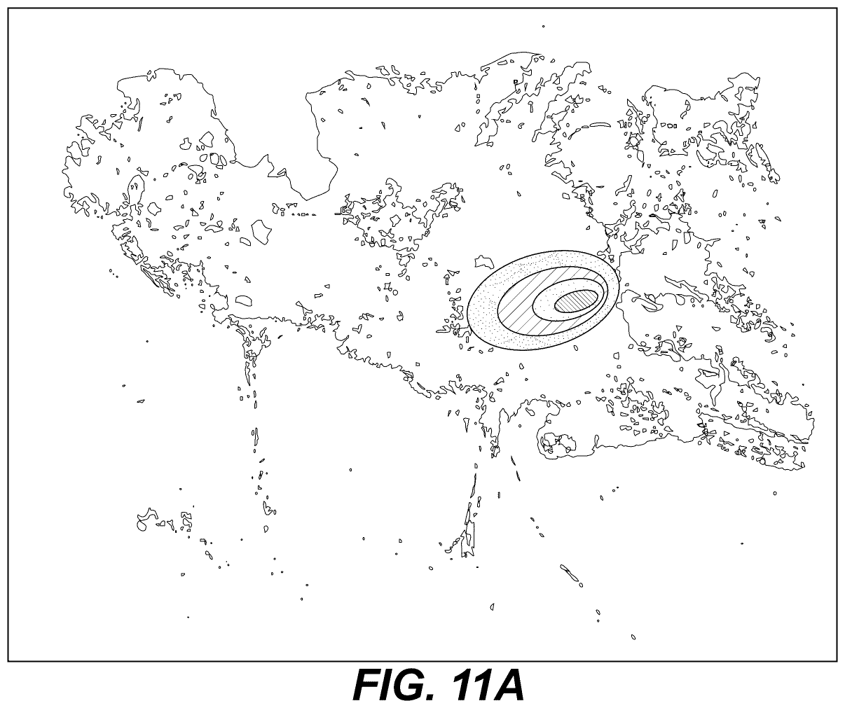

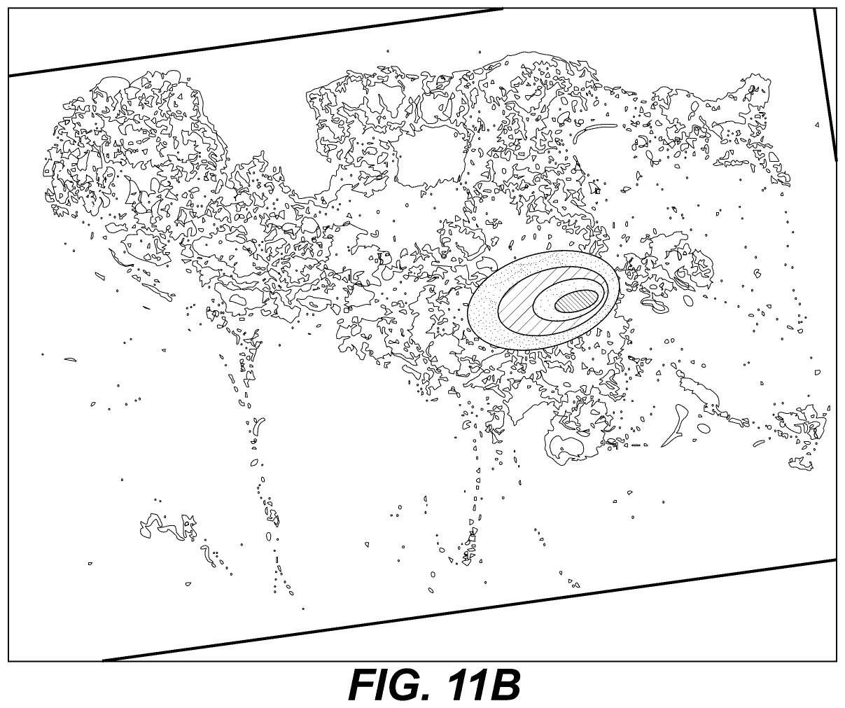

Techniques disclosed herein may have applications in tissue re-staining. In certain pathology applications, a slide can be stained first with a given stain (e.g. H&E), then stripped, and re-stained with IHC. During the restaining process, tissue might move. The current disclosure can be used to align the images of the two stains. FIG. 11A shows a tissue that has been stained with H&E. FIG. 11B shows the same tissue re-stained with IHC. The lines around the tissue image illustrate the movement of the tissue image. Applying the tissue detection, grouping, and registration methods disclosed herein, the H&E and IHC images have been aligned and the heatmap augmentation (generated for one type of staining) can still be placed in the same (or very close) to the original location.

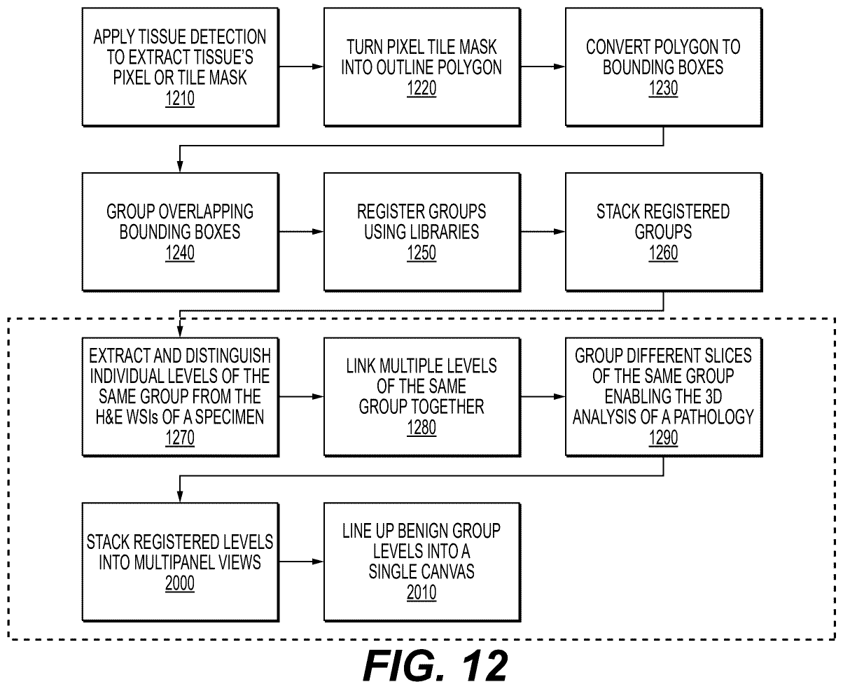

FIG. 12 depicts a flow-chart determining a three-dimensional association of core levels. In step 1210, tissue detection may be applied to extract a pixel or tile mask from a given tissue level. Next, in step 1220, the extracted pixel/tile mask may be turned into one or more outline polygons that may then, in step 1230, be converted to bounding boxes. In step 1240, overlapping bounding boxes may be turned into cores and grouped together, which may be then, in step 1250, registered via libraries. Lastly, in step 1260, registered cores may be stacked together to render a 3D view of a given core. Following this process, one or more additional activities may take place. In some instances, individual levels of the same group may be extracted and distinguished from the H&E WSIs of a specimen, as shown in step 1270. In other instances, multiple levels of the same group may be registered together, as shown in step 1280. In step 1290, different slices of the same group may be grouped together to enable the 3D analysis of a pathology. In other instances, registered levels may be stacked into multipanel views, as shown in step 2000. Additionally, benign group levels may be lined up into a single canvas as shown in step 2010. Specifically, a large canvas capable of including all benign group level may be created and all benign group level may be spatially ordered and pasted adjacent to each other on the canvas. This may make it possible for pathologists to quickly check one large WSI instead of switching between multiple WSIs which in turn will reduce the time to assess a case.

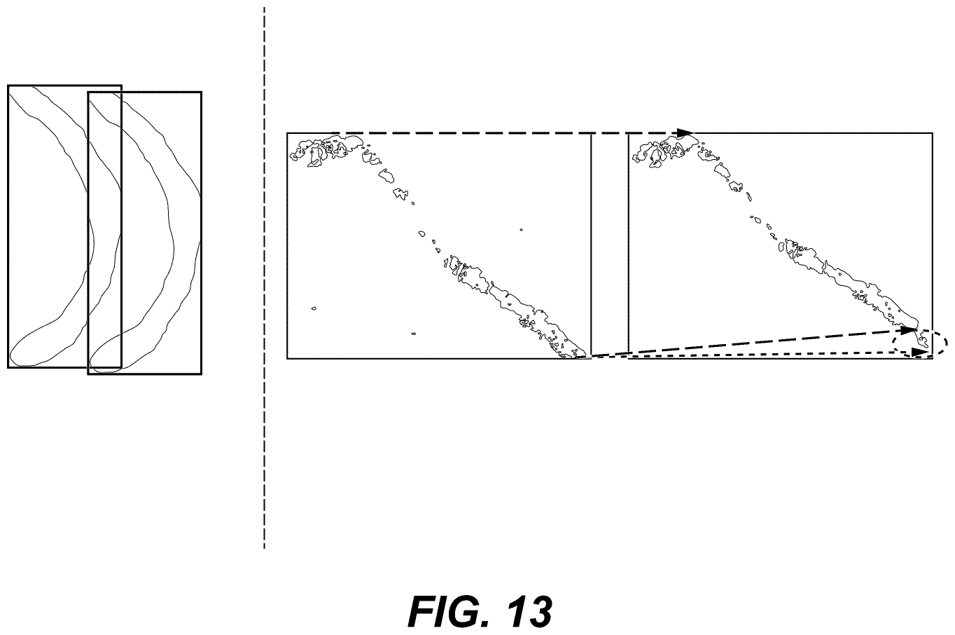

FIG. 13 depicts the challenge of resolving overlapping bounding boxes. This challenge may be addressed by masking out the contents within a given bounding box other than the tissue to which the bounding box associates. This may be followed by applying registration to each possible pair and taking into account only the pairs for which the similarity metric is above a predetermined threshold.

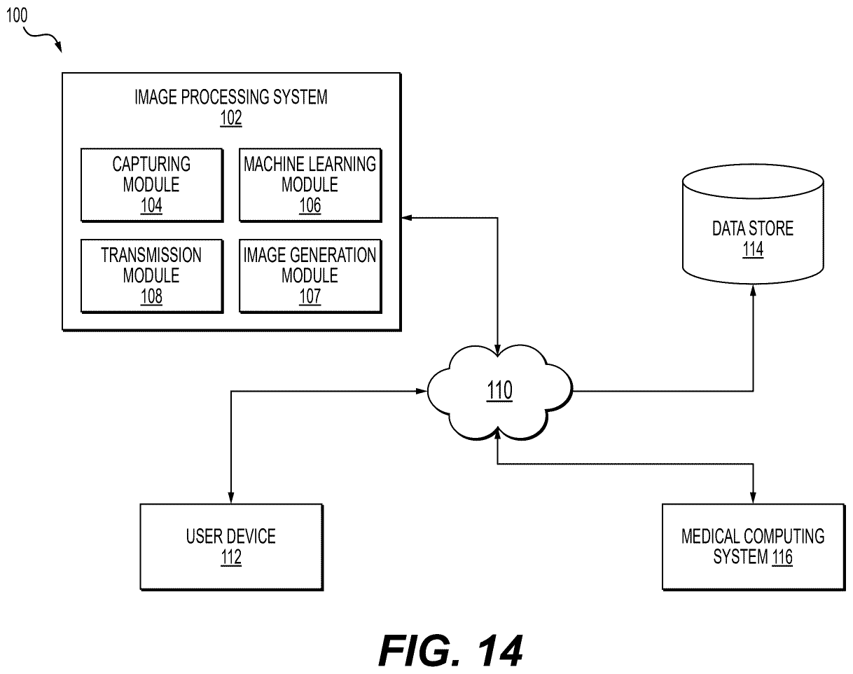

FIG. 14 depicts an exemplary environment 100 that may be utilized with techniques presented herein. One or more user device(s) 112 may communicate across an electronic network 110. The one or more user device(s) 112 may be associated with a user, e.g., a user that is viewing and/or interacting with a generated navigable three-dimensional image, an administrator of one or more components of environment 100, and/or the like. As will be discussed in further detail below, one or more computing system(s) 102 may communicate with one or more of the other components of the environment 100 across electronic network 110.

The user device(s) 112 may be configured to enable a user to access and/or interact with other systems in the environment 100. For example, the user device(s) 112 may each be a computer system such as, for example, a desktop computer, a mobile device, a tablet, an augmented/virtual/extended reality device, and etc. In some embodiments, the user device(s) 112 may include one or more electronic application(s), e.g., a program, plugin, browser extension, etc., installed on a memory of the user device(s) 112. In some embodiments, the electronic application(s) may be associated with one or more of the other components in the environment 100. For example, the electronic application(s) may include one or more of system control software, system monitoring software, software development tools, etc.

In various embodiments, the environment 100 may include a data store 114 (e.g., database). The data store 114 may include a server system and/or a data storage system such as computer-readable memory such as a hard drive, flash drive, disk, etc. In some embodiments, the data store 114 includes and/or interacts with an application programming interface for exchanging data to other systems, e.g., one or more of the other components of the environment. The data store 114 may include and/or act as a repository or source for storing image data, whole slide images (WSI), a generated three-dimensional image, patient data, output data (e.g., from a machine-learning model), and the like (e.g., to be provided/transmitted to user device 112 or to/from any of the other components of environment 100).

In some embodiments, the components of the environment 100 are associated with a common entity, e.g., a service provider, an account provider, or the like. For example, in some embodiments, computing system 102, data store 114, and medical computing system 116 may be associated with a common entity. In some embodiments, one or more of the components of the environment is associated with a different entity than another. For example, computing system 102 may be associated with a first entity (e.g., a service provider) while medical computing system 116 may be associated with a second entity (e.g., a medical institution or provider). The systems and devices of the environment 100 may communicate in any arrangement. As will be discussed herein, systems and/or devices of the environment 100 may communicate in order to one or more of generate, train, or use a machine-learning model to process imaging data, among other activities.

As discussed in further detail below, the computing system(s) 102 may, one or more of, (i) generate, store, train, communicate with, or use a machine-learning model configured to process imaging data. The computing system(s) 102 may include a machine-learning model and/or instructions associated with the machine-learning model, e.g., instructions for generating a machine-learning model, training the machine-learning model, using the machine-learning model etc. The computing system(s) 102 may include instructions for retrieving data, adjusting data, e.g., based on the output of the machine-learning model, and/or operating a display of the user device(s) 112 to output generated responses to input, e.g., as adjusted based on the machine-learning model. The computing system(s) 102 may include training data, e.g., image data, and may include ground truth, e.g., (i) training whole slide images and (ii) training three-dimensional images to generate a navigable three-dimensional image.

As depicted in FIG. 14, computing system(s) 102 may include capturing module 104. In various embodiments, capturing module 104 is configured to receive a plurality of whole slide images (WSI) associated with a tissue sample. The whole slide images and/or associated data may be gathered and/or compiled by the computing system 102 or using components separate from environment 100. In examples, capturing module 104 may receive the whole slide images from medical computing system 116 via network 110. Medical computing system 116 may be a user device associated with a medial institution, a medical imaging device, or the like. A medical imaging device implementing medical computing system 116 may include image processing system 102, or image processing system 102 may be a separate component from medical computing system 116. A plurality of images (e.g., digital or electronic image or a whole slide image (WSI)) may be received into electronic storage (e.g., cloud-based storage, hard disk, RAM, etc.) such as data store 114. Further, and in various embodiments, capturing module 104 may receive patient data. In examples, patient data may include medical records, demographic information, medical predispositions, diagnoses and the like. Such patient data may be received by capturing module 104 from data store 114, medical computing system 116, user device 112, or the like.

In example, such image data and patient data may be provided to one or more image processing machine-learning models. The one or more image processing machine-learning models may be implemented, generated, trained, or the like by machine-learning module 106. The one or more image processing machine-learning models may be trained based on training data that includes historical/genuine/prior patient tissue images and/or simulated/synthetic image data, historical or simulated patient data, and/or the like. Synthetic image generation may use techniques described in U.S. application Ser. No. 17/645,197, which is incorporated herein by reference. The training data may be used to train the image processing machine-learning models by modifying one or more weights, layers, synapses, biases, and/or the like of the image processing machine-learning models, in accordance with a machine-learning algorithm, as discussed herein. Alternatively, or in addition, such image data may be used to generate a three-dimensional image.

Computing system(s) 102 may also include image generation module 107. In various embodiments, image generation module 107 may be configured to generate a navigable three-dimensional image of a tissue sample based on an output of the one or more machine-learning models. In various embodiments, image generation module 107 may also be configured to generate an interactive display that incorporates the navigable three-dimensional image. In examples, the interactive display enables a user to navigate aspects of the three-dimensional image (e.g., zoom in/out, rotate, flip, view a cross-section, “peel back” layers of the three-dimensional image to view interior aspects, and the like). In further examples, the interactive display that incorporates the navigable three-dimensional image may be operable and/or configured to enable a user to navigate sample levels (e.g., tissue depths of the tissue sample associated with the image(s). Each level may be associated with a WSI). In other various embodiments, image generation module 107 may be configured to generate a side-by-side display incorporating graphical representations of two or more images (e.g., whole slide images). In various additional embodiments, image generation module 107 may be configured to place a set of whole slide images in an order based an output of a machine-learning model, and may be further configured to “stitch” the whole slide images together based on the ordering.

As depicted in FIG. 14, computing system(s) 102 may also include transmission module 108. In various embodiments, transmission module 107 may be configured to transmit the interactive display, the side-by-side display, and/or the generated navigable three-dimensional image to a user interface, such as of user device 112. In further embodiments, transmission module 107 may be further configured to transmit the aforementioned to data store 114 (e.g., for storage or retention), or to medical computing system 116 (e.g., for storage, display, further processing, or the like).

As depicted in FIG. 14, environment 100 may also include electronic network 110. In various embodiments, the electronic network 110 may be a wide area network (“WAN”), a local area network (“LAN”), personal area network (“PAN”), or the like. In some embodiments, electronic network 110 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

Although depicted as separate components in FIG. 14, it should be understood that a component or portion of a component in the environment 100 may, in some embodiments, be integrated with or incorporated into one or more other components. In another example, the computing system 102 may be integrated in a data storage system. The data storage system may be configured to communicate and/or receive/send data across electronic network 110 to other components of environment 100. In some embodiments, operations or aspects of one or more of the components discussed above may be distributed amongst one or more other components. Any suitable arrangement and/or integration of the various systems and devices of the environment 100 may be used.

It should be understood that in various embodiments, various components of the environment 100 discussed above may execute instructions or perform acts including the acts discussed above. An act performed by a device may be considered to be performed by a processor, actuator, or the like associated with that device. Further, it should be understood that in various embodiments, various steps may be added, omitted, and/or rearranged in any suitable manner.

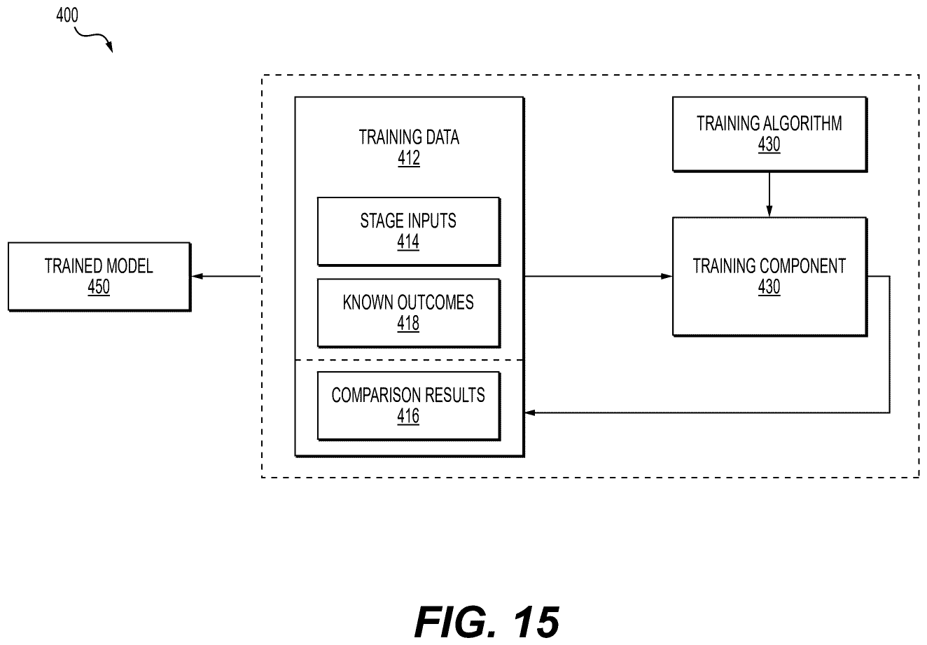

FIG. 15 depicts a flow diagram for training a machine-learning model. As shown in flow diagram 400 of FIG. 15, training data 412 may include one or more of stage inputs 414 and known outcomes 418 related to a machine-learning model to be trained. The stage inputs 414 may be from any applicable source including a component or set shown in the figures provided herein. The known outcomes 418 may be included for machine-learning models generated based on supervised or semi-supervised training. An unsupervised machine-learning model might not be trained using known outcomes 418. Known outcomes 418 may include known or desired outputs for future inputs similar to or in the same category as stage inputs 414 that do not have corresponding known outputs.

The training data 412 and a training algorithm 420 may be provided to a training component 430 that may apply the training data 412 to the training algorithm 420 to generate a trained machine-learning model 450. According to an implementation, the training component 430 may be provided comparison results 416 that compare a previous output of the corresponding machine-learning model to apply the previous result to re-train the machine-learning model. The comparison results 416 may be used by the training component 430 to update the corresponding machine-learning model. The training algorithm 420 may utilize machine-learning networks and/or models including, but not limited to a deep learning network such as Graph Neural Networks (GNN), Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 400 may be a trained machine-learning model 450.

A machine-learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine-learning model (e.g., a trained model) based on the training. Once trained, the machine-learning model may output machine-learning model outputs in accordance with the subject matter disclosed herein. According to an implementation, one or more machine-learning models disclosed herein may continuously be updated based on feedback associated with use or implementation of the machine-learning model outputs.

It should be understood that aspects in this disclosure are exemplary only, and that other aspects may include various combinations of features from other aspects, as well as additional or fewer features.

In general, any process or operation discussed in this disclosure that is understood to be computer-implementable, such as the processes illustrated in the flowcharts disclosed herein, may be performed by one or more processors of a computer system, such as any of the systems or devices in the exemplary environments disclosed herein, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices disclosed herein. One or more processors of a computer system may be included in a single computing device or distributed among a plurality of computing devices. A memory of the computer system may include the respective memory of each computing device of the plurality of computing devices.

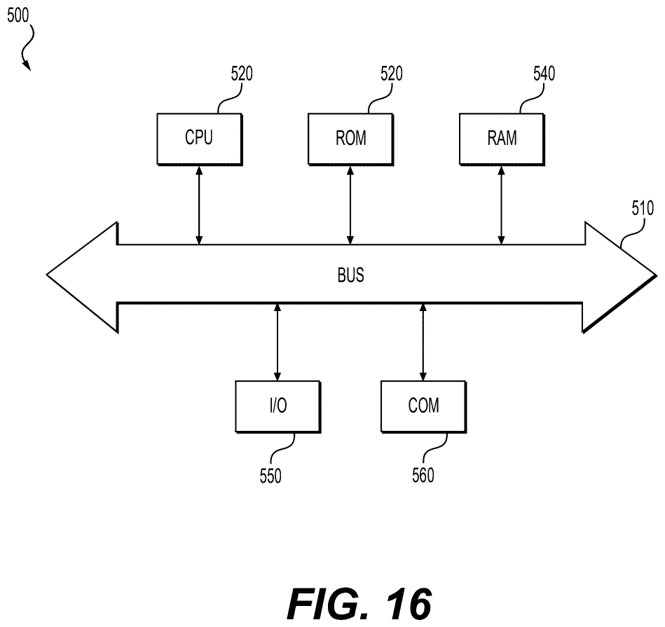

As shown in FIG. 16, device 500 may include a central processing unit (CPU) 520. CPU 520 may be any type of processor device including, for example, any type of special purpose or a general-purpose microprocessor device. As will be appreciated by persons skilled in the relevant art, CPU 520 also may be a single processor in a multi-core/multiprocessor system, such system operating alone, or in a cluster of computing devices operating in a cluster or server farm. CPU 520 may be connected to a data communication infrastructure 510, for example a bus, message queue, network, or multi-core message-passing scheme.

Device 500 may also include a main memory 540, for example, random access memory (RAM), and also may include a secondary memory 530. Secondary memory 530, e.g. a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 530 may include similar means for allowing computer programs or other instructions to be loaded into device 500. Examples of such means may include a program cartridge and cartridge interface (such as that found in video game devices), a removable memory chip (such as an EPROM or PROM) and associated socket, and other removable storage units and interfaces, which allow software and data to be transferred from a removable storage unit to device 500.

Device 500 also may include a communications interface (“COM”) 560. Communications interface 560 allows software and data to be transferred between device 500 and external devices. Communications interface 560 may include a modem, a network interface (such as an Ethernet card), a communications port, a PCMCIA slot and card, or the like. Software and data transferred via communications interface 560 may be in the form of signals, which may be electronic, electromagnetic, optical or other signals capable of being received by communications interface 560. These signals may be provided to communications interface 560 via a communications path of device 500, which may be implemented using, for example, wire or cable, fiber optics, a phone line, a cellular phone link, an RF link or other communications channels.

The hardware elements, operating systems, and programming languages of such equipment are conventional in nature, and it is presumed that those skilled in the art are adequately familiar therewith. Device 500 may also include input and output ports 550 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

Throughout this disclosure, references to components or modules generally refer to items that logically may be grouped together to perform a function or group of related functions. Like reference numerals are generally intended to refer to the same or similar components. Components and/or modules may be implemented in software, hardware, or a combination of software and/or hardware.

The tools, modules, and/or functions described above may be performed by one or more processors. “Storage” type media may include any or all of the tangible memory of the computers, processors or the like, or associated modules thereof, such as various semiconductor memories, tape drives, disk drives and the like, which may provide non-transitory storage at any time for software programming.

Software may be communicated through the Internet, a cloud service provider, or other telecommunication networks. For example, communications may enable loading software from one computer or processor into another. As used herein, unless restricted to non-transitory, tangible “storage” media, terms such as computer or machine “readable medium” refer to any medium that participates in providing instructions to a processor for execution.

One or more techniques presented herein may enable a user, to better interact with a digital image of a glass slide that may be presented on a screen, in a virtual reality environment, in an augmented reality environment, or via some other form of visual display. One or more techniques presented herein may enable a natural interaction closer to traditional microscopy with less fatigue than using a mouse, keyboard, and/or other similar standard computer input devices.

The controllers disclosed herein may be comfortable for a user to control. The controllers disclosed herein may be implemented anywhere that digital healthcare is practiced, namely in hospitals, clinics, labs, and satellite or home offices. Standard technology may facilitate connections between input devices and computers (USB ports, Bluetooth (wireless), etc.) and may include customer drivers and software for programming, calibrating, and allowing inputs from the device to be received properly by a computer and visualization software.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed aspects may be applicable to any environment, such as a desktop or laptop computer, an automobile entertainment system, a home entertainment system, etc. Also, the disclosed aspects may be applicable to any type of Internet protocol.

It should be appreciated that in the above description of exemplary aspects of the invention, various features of the invention are sometimes grouped together in a single aspect, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed aspect. Thus, the claims following the Detailed Description are hereby expressly incorporated into this Detailed Description, with each claim standing on its own as a separate aspect of this invention.

Furthermore, while some aspects described herein include some but not other features included in other aspects, combinations of features of different aspects are meant to be within the scope of the invention, and form different aspects, as would be understood by those skilled in the art. For example, in the following claims, any of the claimed aspects can be used in any combination.

Thus, while certain aspects have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Operations may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

1. A computer-implemented method for analyzing electronic medical images, comprising:
receiving a plurality of medical images associated with a patient;
determining one or more bounding shapes for each of the plurality of medical images, each of the bounding shapes surrounding to a continuous tissue sample depicted in the plurality of medical images;
based on the one or more bounding shapes, determining a plurality of levels of the tissue sample; and
determining a three-dimensional association of the plurality of levels.

2. The method of claim 1, wherein the bounding shapes are determined by determining the images of a tissue sample and identifying a contour region of each tissue.

3. The method of claim 1, wherein determining a three-dimensional association comprises determining an order of the plurality of levels of the tissue sample based on a similarity index.

4. The method of claim 1, further comprising:
stacking and displaying, based on the three-dimensional association, the plurality of levels into at least one multipanel view.

5. The method of claim 1, further comprising:
determining a plurality of benign core levels; and
rendering the plurality of benign core levels into a single image view.

6. The method of claim 1, wherein the plurality of medical images come from a single tissue that has been restained, and wherein the plurality of medical images are stacked to identify the same region across the plurality of medical images.

7. The method of claim 1, wherein the bounding shapes comprise boxes.

8. A system for analyzing electronic medical images, the system comprising:
at least one memory storing instructions; and
at least one processor configured to execute the instructions to perform operations comprising:
receiving a plurality of medical images associated with a patient;
determining one or more bounding shapes for each of the plurality of medical images, each of the bounding shapes surrounding to a continuous tissue sample depicted in the plurality of medical images;
based on the one or more bounding shapes, determining a plurality of levels of the tissue sample; and
determining a three-dimensional association of the plurality of levels.

9. The system of claim 8, wherein the bounding shapes are determined by determining the images of a tissue sample and identifying a contour region of each tissue.

10. The system of claim 8, wherein determining a three-dimensional association comprises determining an order of the plurality of levels of the tissue sample based on a similarity index.

11. The system of claim 8, further comprising:
stacking and displaying, based on the three-dimensional association, the plurality of levels into at least one multipanel view.

12. The system of claim 8, further comprising:
determining a plurality of benign core levels; and
rendering the plurality of benign core levels into a single image view.

13. The system of claim 8, wherein the plurality of medical images come from a single tissue that has been restained, and wherein the plurality of medical images are stacked to identify the same region across the plurality of medical images.

14. The system of claim 8, wherein the bounding shapes comprise boxes.

15. A non-transitory computer-readable medium storing instructions that, when executed by a processor, perform operations analyzing electronic medical images, the operations comprising:
receiving a plurality of medical images associated with a patient;
determining one or more bounding shapes for each of the plurality of medical images, each of the bounding shapes surrounding to a continuous tissue sample depicted in the plurality of medical images;
based on the one or more bounding shapes, determining a plurality of levels of the tissue sample; and
determining a three-dimensional association of the plurality of levels.

16. The computer-readable medium of claim 15, wherein the bounding shapes are determined by determining the images of a tissue sample and identifying a contour region of each tissue.

17. The computer-readable medium of claim 15, wherein determining a three-dimensional association comprises determining an order of the plurality of levels of the tissue sample based on a similarity index.

18. The computer-readable medium of claim 15, further comprising:
stacking and displaying, based on the three-dimensional association, the plurality of levels into at least one multipanel view.

19. The computer-readable medium of claim 15, further comprising:
determining a plurality of benign core levels; and
rendering the plurality of benign core levels into a single image view.

20. The computer-readable medium of claim 15, wherein the plurality of medical images come from a single tissue that has been restained, and wherein the plurality of medical images are stacked to identify the same region across the plurality of medical images.
